(19) United States
(12) Patent Application Publication
(10) Pub. No.: US 2026/0354610 A1
(43) Pub. Date: Nov. 12, 2026

(54) MAGNETIC BRACKET FOR RAIL OF WINDOW COVERING

(71) Applicant: CHING FENG HOME FASHIONS CO., LTD., Chang-Hwa (TW)

(72) Inventors: Wen-Ying Liang, Lukang Township (TW); Ching-Chia Chen, Fuxing Township (TW)

(73) Assignee: CHING FENG HOME FASHIONS CO., LTD., Chang-Hwa (TW)

(21) Appl. No.: 19/202,411

(22) Filed: May 8, 2025

(51) Int. Cl. A47H 1/144; H01F 7/02

(52) U.S. Cl. CPC A47H 1/144; H01F 7/0252

(57) ABSTRACT

A magnetic bracket for a rail of a window covering includes a magnetically attachable base that has a top side, a bottom side, and a peripheral side connecting the top side and the bottom side. The magnetically attachable base is provided therein with plural magnets and plural iron plates. The top side is provided with a coupling portion. The coupling portion is provided with a rail engaging member. The bottom side is provided with at least one gradually widening inclined sidewall that extends toward the top side such that the width of the magnetically attachable base in an axial direction thereof is gradually increased in a direction from the bottom side to the top side until a greatest width is formed. The greatest width of the magnetically attachable base in the axial direction is greater than the width of the bottom side in the axial direction.

### BACKGROUND OF THE INVENTION

### 1. Technical Field

The present invention relates to equipment for mounting and fixing a rail of a window covering. More particularly, the invention relates to a magnetic bracket for a rail of a window covering.

### 2. Description of Related Art

Referring to FIGS. 1-3, the structure of a commercially available magnetic bracket for a rail of a window covering includes a magnetically attachable base 1. The magnetically attachable base 1 is generally a cuboid and has a top side 2, a bottom side 3, and a peripheral side 4 that connects the top side and the bottom side. The magnetically attachable base 1 is provided therein with a plurality of magnets and a plurality of magnetically permeable iron plates 5. The magnets constitute a magnet set, and each magnetically permeable iron plate 5 is provided either on one of two opposite lateral sides of the magnet set or in one of the gaps between the magnets. The top side 2 of the magnetically attachable base is provided with a coupling portion 6. The coupling portion 6 is provided with a rail engaging member 7 for engaging with and thereby fixing a rail of a window covering. To use, the magnetic bracket has its bottom side 3 magnetically attached to a flat surface of a ferromagnetic metal (which can be magnetically attracted), wherein the flat surface (e.g., of a window frame or door panel) is where the magnetic bracket is to be mounted. After that, a rail of a window covering is engaged with the rail engaging member 7.

While the structure described above is easy to use in terms of mounting, it is far from easy to detach the magnetic bracket from the flat surface. This is mainly because, first, the bottom side 3 of the magnetically attachable base 1 lies flat on the flat surface of the ferromagnetic metal when the magnetically attachable base is magnetically attached to the flat surface, and, second, the magnets generally have a relatively great magnetic force F in order to prevent the rail of the window covering from falling off. (Here, referring to FIG. 2, the magnetic attraction force applied to the flat surface of the ferromagnetic metal by the magnets and the magnetically permeable iron plates is defined as F1 + F2 + F3 + F4.) In addition, the peripheral side 4 of the magnetically attachable base is a vertical wall (for the definition of the term “vertical,” please refer to the directions shown in FIG. 2), so a user wishing to detach the magnetically attachable base 1 lacks a point of force application and may have problem gripping the magnetically attachable base; and due to the great magnetic attraction force of the bottom side 3, the user may try to remove the magnetically attachable base by turning it about the fulcrum O in the lower left corner of FIG. 2. In response to the turning operation, the illustrated conventional product produces a resisting torque L2 that can be estimated as follows. Assume the distance between each two adjacent magnetically permeable iron plates is D. By calculating the length of each moment arm from the fulcrum O rightward, the resisting torque produced by the magnetic attraction force of the bottom side of the magnetically attachable base is D × F1 + 2D × F2 + 3D × F3 + 4D × F4 = L2. To turn the magnetically attachable base successfully, the applied torque L1 produced by the force applied by the user to turn the magnetically attachable base must be greater than the resisting torque L2 produced by the magnetic attraction force of the bottom side. Therefore, unless a tool is used, it is difficult to remove the magnetically attachable base.

### BRIEF SUMMARY OF THE INVENTION

The primary objective of the present invention is to provide a magnetic bracket for a rail of a window covering, wherein the magnetic bracket is structurally simple and can be easily and effortlessly detached.

To achieve the foregoing objective, the magnetic bracket provided by the present invention for a rail of a window covering includes a magnetically attachable base. The magnetically attachable base has a top side, a bottom side, and a peripheral side connecting the top side and the bottom side. The top side is provided with a coupling portion. The coupling portion is provided with a rail engaging member. The magnetically attachable base is provided therein with a plurality of magnets and a plurality of iron plates. The bottom side is provided with at least one gradually widening inclined sidewall that extends toward the top side, and because of that, the width of the magnetically attachable base in one axial direction of the magnetically attachable base is gradually increased in a direction from the bottom side to the top side and ends up reaching the greatest width of the magnetically attachable base in the axial direction, wherein the greatest width is greater than the width of the bottom side in the axial direction.

Given the aforesaid structure, the magnetic bracket provided by the present invention for a rail of a window covering not only can be used as conveniently as the conventional product described above, but also allows the magnetically attachable base to be detached by being gripped at desirable points of force application and turned with a longer moment arm than provided by the conventional product. Thus, the objective of the invention is achieved.

### BRIEF DESCRIPTION OF THE SEVERAL VIEWS OF THE DRAWINGS

FIG. 1 is a perspective view of a conventional product.

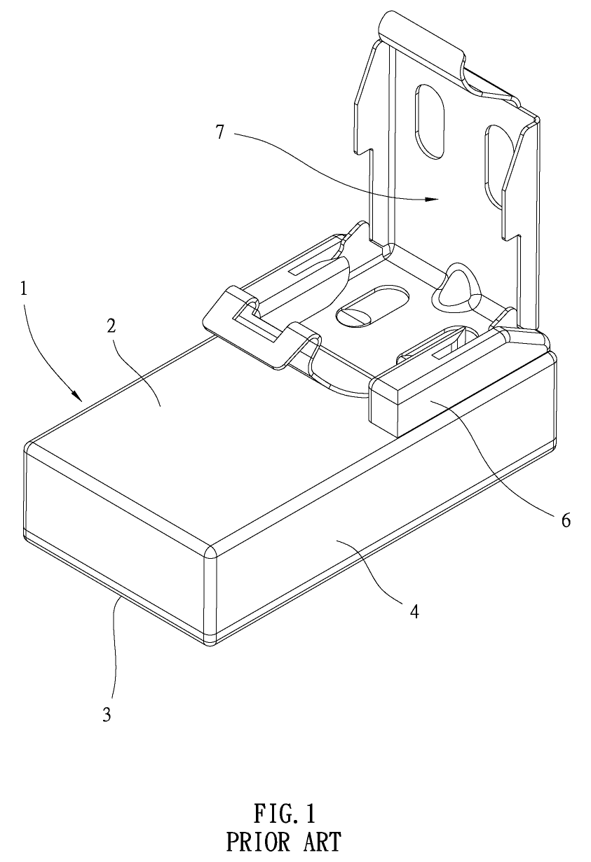

FIG. 2 is a front view of the conventional product shown in FIG. 1.

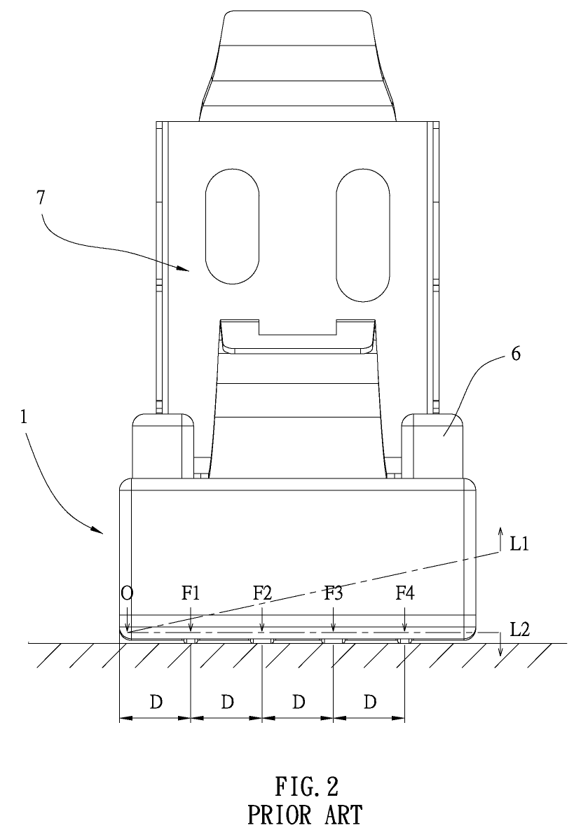

FIG. 3 shows the conventional product in FIG. 1 from yet another viewing angle.

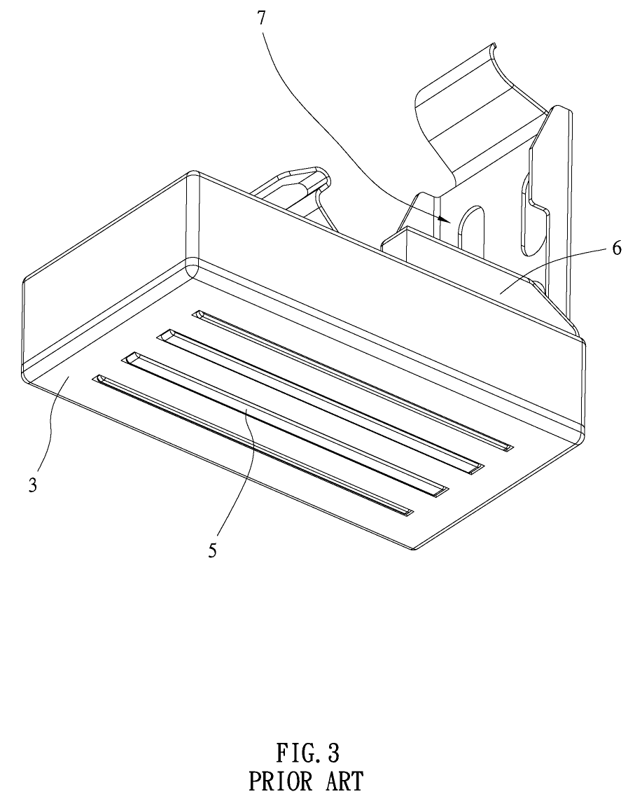

FIG. 4 is a perspective view of the present invention.

FIG. 5 is another perspective view of the present invention, taken from a different viewing angle from that of FIG. 4.

FIG. 6 is an exploded view of the present invention, showing the magnetically attachable base separated from the rail engaging member.

FIG. 7 is a side view of the present invention.

FIG. 8 is a front view of the present invention.

### DETAILED DESCRIPTION OF THE INVENTION

To begin with, the applicant would like to point out that, throughout this specification, which includes the following description of an embodiment and the appended claims, all the direction-related terms make reference to the directions shown in the accompanying drawings. In addition, in the embodiment described below and the drawings, identical or similar elements or structural features are designated by the same reference numeral. Moreover, although the directions stated in this specification make reference to the directions in the drawings to facilitate description, the stated directions are not limited to those illustrated herein.

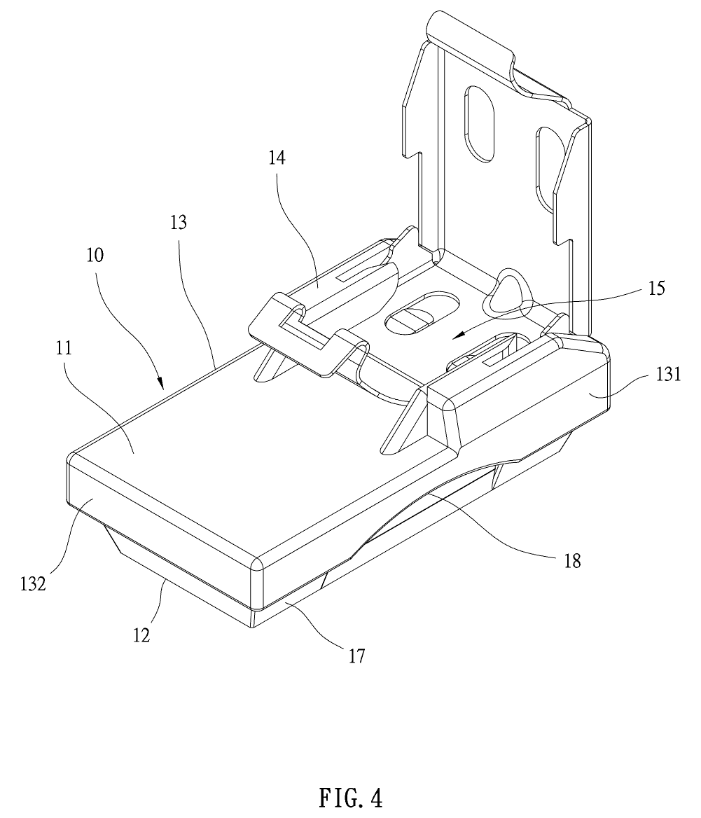

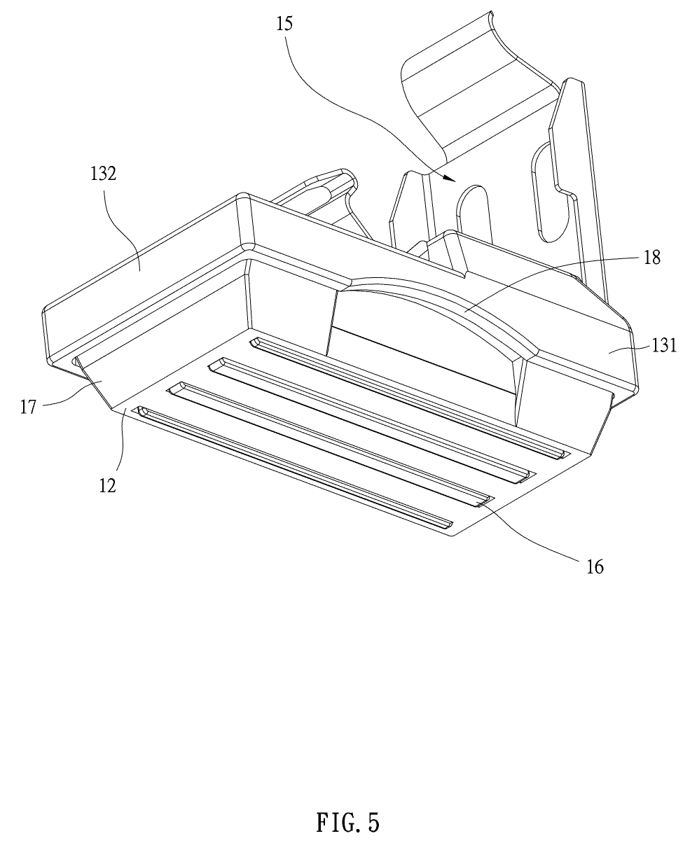

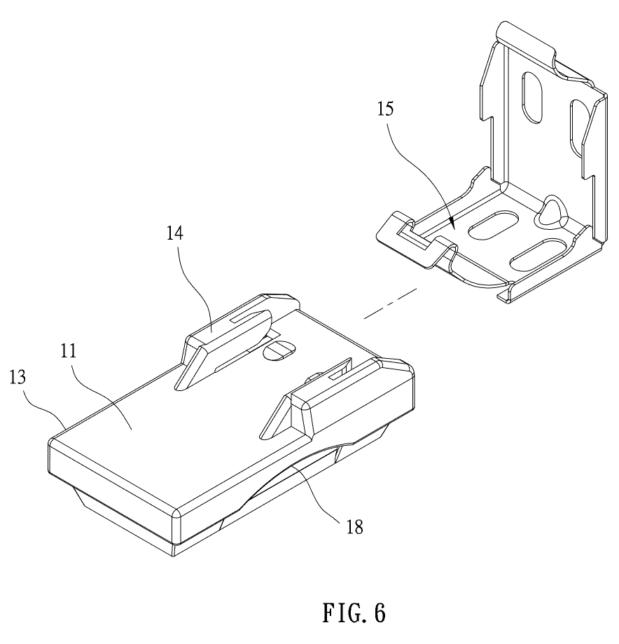

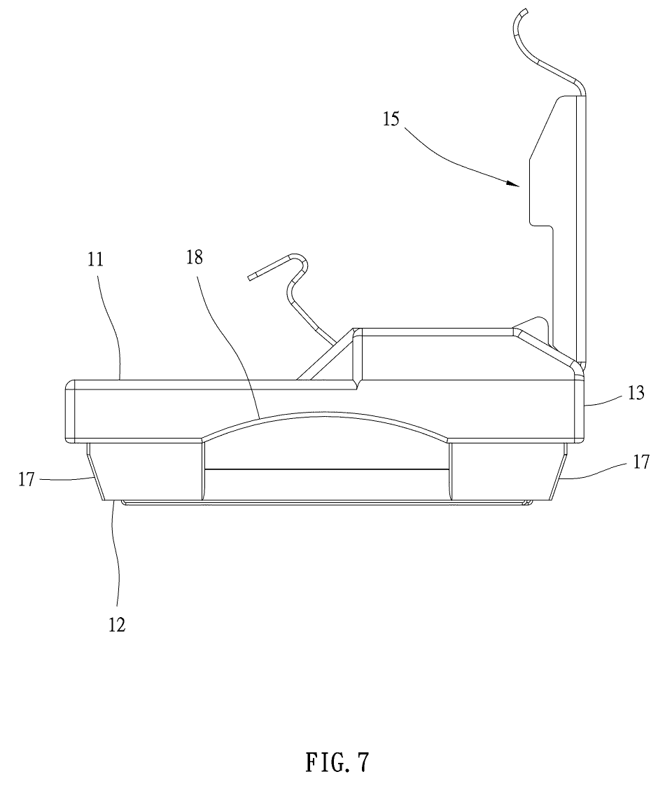

Referring to FIG. 4 to FIG. 8, the magnetic bracket for a rail of a window covering according to an embodiment of the present invention includes a magnetically attachable base 10.

The magnetically attachable base 10 has a top side 11, a bottom side 12, and a peripheral side 13 that connects the top side and the bottom side. The top side 11 is provided with a coupling portion 14. The coupling portion 14 is provided with a rail engaging member 15, and the rail engaging member is configured to engage with a rail of a window covering. The magnetically attachable base 10 is provided therein with a plurality of magnets and a plurality of iron plates 16. The iron plates 16 are exposed from the surface of the bottom side 12. In this embodiment, the magnetically attachable base 10 is a rectangular body and therefore has two long sides 131 and two short sides 132. The magnetically attachable base 10, however, is not limited to this configuration and may be a cylinder, a hexagonal prism, a triangular prism, or of another shape. The distance between each outermost iron plate and the corresponding long side is less than or equal to the distance by which each iron plate protrudes from the bottom side.

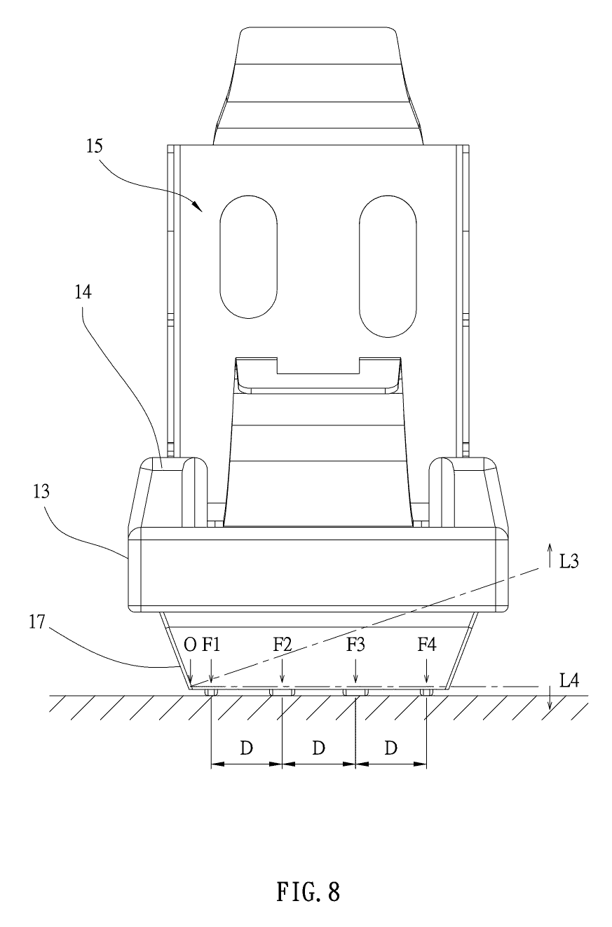

The bottom side 12 is provided with at least one gradually widening inclined sidewall 17 that extends toward the top side 11. Therefore, the width of the magnetically attachable base 10 in one axial direction of the magnetically attachable base is gradually increased in a direction from the bottom side 12 to the top side 11 until a greatest width is formed. The greatest width of the magnetically attachable base 10 in the axial direction is greater than the width of the bottom side 12 in the axial direction. More specifically, referring to FIG. 8 and the directions shown therein, the two ends of the bottom side in the short-axis direction (i.e., the two long sides 131 flanking the bottom side 12) are each provided with an inclined sidewall 17 that extends toward the top side 11, so the bottom side 12 has a width in the short-axis direction that increases as the two inclined sidewalls 17 gradually extend outward. Preferably, the width of the bottom side 12 in the short-axis direction is less than or equal to the width of the rail engaging member 15 in the same axial direction.

In this embodiment, the bottom side is provided with an inclined sidewall 17 at each of the two short sides 132 as well as at each of the two long sides 131, and all the inclined sidewalls 17 gradually widen toward the top side 11. The number of the inclined sidewalls 17, however, is not limited to four. It is feasible for an inclined sidewall 17 that gradually widens toward the top side 11 to be provided only at each of the two long sides 131 but not at any of the two short sides 132. If the magnetically attachable base 10 has a cylindrical shape, the at least one inclined sidewall 17 will be an annular inclined sidewall. Each/the inclined sidewall 17 may extend from the bottom side 12 all the way to the top side 11 and thus have a downwardly tapered configuration, or as shown in this embodiment, each/the inclined sidewall 17 may extend outward only to a predetermined height and is then connected to the vertical peripheral side 13. Each of the two long sides 131 of the magnetically attachable base is provided with a recess portion 18 that serves as a point of force application to make it easier for a user to turn the magnetically attachable base.

The foregoing structure of the present invention allows the magnetically attachable base 10 to be mounted and used in the same way as the conventional product described above, i.e., to be magnetically attached to a mounting position through the magnetic force of the magnets in the magnetically attachable base. Here, by way of example, the magnetic attraction force of the magnets has the same magnitude as that of the conventional product described above, namely F1 + F2 + F3 + F4. When it is desired to remove the magnetically attachable base, the recess portions 18 of the two long sides of the magnetically attachable base can be used for gripping and as the points of force application for turning the magnetically attachable base. Referring to FIG. 8 and the directions shown therein, when the user grips the magnetically attachable base by the recess portions 18 and turns the magnetically attachable base in the same way as stated above (i.e., by rotating the magnetically attachable base counterclockwise about the fulcrum O in the lower left corner of FIG. 8), the resulting resisting torque can be roughly estimated as follows. The bottom side in the invention is narrower than that of the conventional product, so the distance between each outermost iron plate and the corresponding long side will be very short; in consequence, the fulcrum O can be viewed as located at the position of F1. By calculating the length of each moment arm from the fulcrum O rightward, the resisting torque produced by the bottom side in the invention is D × F2 + 2D × F3 + 3D × F4 = L4, which is significantly less than the resisting torque produced by the conventional product.

The force applied by the user produces a turning torque L3, and the magnetic attraction force of the magnets in the magnetically attachable base produces the resisting torque L4, i.e., a magnetic attraction torque, to resist the turning torque. Structurally speaking, it is obvious that the moment arm of the turning torque L3 has a far greater length than the moment arm of the magnetic attraction torque L4, and according to the working principle of a lever, the longer the moment arm, the less the applied force required. Now that the resisting torque of the invention is less than that of the conventional product, the magnetically attachable base can be effortlessly turned by the user so that the bottom side of the magnetically attachable base is no longer magnetically attached to the flat surface, and in doing so, the objective of removing the magnetically attachable base effortlessly is achieved.

1. A magnetic bracket for a rail of a window covering, the magnetic bracket comprising:
a magnetically attachable base having a top side, a bottom side, and a peripheral side connecting the top side and the bottom side, wherein the top side is provided with a coupling portion, the coupling portion is provided with a rail engaging member, and the bottom side is provided therein with a plurality of magnets and a plurality of iron plates;
wherein the bottom side is provided with a gradually widening inclined sidewall extending toward the top side such that the magnetically attachable base has a width defined in an axial direction of the magnetically attachable base and gradually increased in a direction from the bottom side to the top side until a greatest width is formed, and the junction of the gradually widening inclined sidewall and the peripheral side forms a shoulder that inward and has a step, and the greatest width of the magnetically attachable base in the axial direction is greater than a width of the bottom side in the axial direction.

2. The magnetic bracket for a rail of a window covering as claimed in claim 1, wherein the width of the bottom side in the axial direction is less than or equal to a width of the rail engaging member in the axial direction.

3. The magnetic bracket for a rail of a window covering as claimed in claim 1, wherein the magnetically attachable base is a rectangular body and has two long sides and two short sides.

4. The magnetic bracket for a rail of a window covering as claimed in claim 3, wherein the bottom side is provided with a said inclined sidewall at each of the two long sides, and the inclined sidewalls gradually widen toward the top side.

5. The magnetic bracket for a rail of a window covering as claimed in claim 4, wherein the inclined sidewalls extend outward to a predetermined height and are then connected to the peripheral side.

6. The magnetic bracket for a rail of a window covering as claimed in claim 5, wherein each of the two long sides of the magnetically attachable base is provided with a recess portion.

7. The magnetic bracket for a rail of a window covering as claimed in claim 3, wherein the bottom side is provided with a said inclined sidewall at each of the two short sides, and the inclined sidewalls gradually widen toward the top side.

8. The magnetic bracket for a rail of a window covering as claimed in claim 7, wherein the inclined sidewalls extend outward to a predetermined height and are then connected to the peripheral side.

9. The magnetic bracket for a rail of a window covering as claimed in claim 1, wherein the inclined sidewall extends outward to a predetermined height and is then connected to the peripheral side.

10. The magnetic bracket for a rail of a window covering as claimed in claim 3, wherein a distance between each outermost iron plate of the plurality of iron plates and a corresponding one of the long sides along the bottom side is less than or equal to a distance by which each of the iron plates protrudes from the bottom side.
